(19) United States
(12) Patent Application Publication
(10) Pub. No.: US 2004/0135384 A1
(43) Pub. Date: Jul. 15, 2004

(54) Bumper assembly

(75) Inventors: Christopher S. Pritchard, Farmington Hills, MI (US); Benjamin Roger Zabik, Ann Arbor, MI (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Meridian Automotive Systems, Inc.

(21) Appl. No.: 10/731,293

(22) Filed: Dec. 9, 2003

Related U.S. Application Data
(60) Provisional application No. 60/433,513, filed on Dec. 13, 2002.

(51) Int. Cl. B60R 19/56

(52) U.S. Cl. 293/120

(57) ABSTRACT

A bumper assembly and a process of fabricating the assembly that is designed to increase kinetic energy absorption and reduce deflection during a vehicular impact event. The bumper assembly comprising a vehicular bumper beam, a pair of mounting brackets that attach the bumper beam to a vehicular frame, and a fascia that partially encloses the bumper beam. The vehicular bumper is a structural cross member with two or more beads on an impact face of the bumper beam.

### BACKGROUND OF THE INVENTION

1. Field of the Invention

This invention relates generally to an improved bumper assembly for a vehicle. More specifically, this invention relates to a bumper assembly comprising a bumper beam with multiple longitudinal beads, or ridges, on the impact surface of the bumper. The bumper assembly of the invention is designed to increase kinetic energy absorption and reduce deflection during a vehicular impact event. This application claims benefit of U.S. Provisional Patent Application Serial No. 60/433,513, filed Dec. 13, 2002.

2. Background of Related Art

Vehicular bumper assemblies protect vehicles from damage sustained during low speed collisions. Bumper assemblies' primary function is to absorb or store kinetic energy produced from a vehicular impact event, i.e., a collision.

Designing a bumper assembly to deflect in a continuous process without a sudden failure optimizes its performance. Generally, failure occurs when the impact face of the bumper buckles under compressive load, causing the cross section of the bumper beam to collapse.

There are different bumper beam assemblies known in the art that attempt optimize performance. Bumper assemblies, typically, include a metallic bumper beam, made from either aluminum or steel. The traditional bumper beam is formed from this walled tubes or open section beams of various designs. Most often, the bumper beam has a semi-flat, swept plate impact face.

For example, in a known prior art bumper system, the bumper beam comprises a unitary beam member mounted near each end to outer ends of vehicle structural rails in a “B-section” stamped version of a bumper beam. This bumper system's bumper beam is metallic and further comprises an energy foam absorber, or an expanded polypropylene isolator, as well as optional center reinforcement.

Therefore, an improved bumper assembly that increases the resistance of the bumper to a buckling failure and prevents collapsing, while eliminating the need for an energy absorber or isolator, would be advantageous.

### BRIEF DESCRIPTION OF THE DRAWINGS

In the drawings:

FIG. 1 is a schematic view of an improved bumper assembly comprising a metallic bumper beam with stiffening beads that is attached to a vehicular frame by mounting brackets as according to the invention;

FIG. 2 is a C-Type cross-sectional view of a “C-Type” bumper beam of the present invention;

FIG. 3 is a cross-sectional view of an “M-Type” bumper beam of the present invention;

FIG. 4 is a cross-sectional view of a “C-Type” bumper beam of the p and a M-Type cross-sectional view of a bumper beam with two stiffening beads as according to the invention; and

FIG. 5 is a schematic view of a bumper assembly comprising the center reinforcement.

### DETAILED DESCRIPTION

The invention relates to an improved vehicular bumper assembly, and, more specifically, to a bumper assembly that incorporates a bumper beam with two or more longitudinal beads, or ridges, on the impact surface of the structural member that makes up the bumper beam.

The improvements of the invention are quantified by increased kinetic energy absorption and reduced deflection during a vehicular impact event. A bumper beam assembly with multiple stiffening beads results in a bumper beam that can absorb or store more kinetic energy before failing, in comparison to a bumper beam without beads. Moreover, the beads increase the resistance of the impact face of the bumper beam to a buckling failure, thereby increasing the resistance of the beam to collapsing. As used herein, a “bead” is defined as a defined shape, such as a semi-circular, semi-elliptical, semi-square, semi-rectangular, semi-triangular, or semi-trapezoidal shape, with or without radiused corners, that projects from the impact face of a bumper beam, that is integral to and runs longitudinally along at least a portion of the length of the bumper beam, and is less than half the height of the bumper beam cross-section. Preferably, the height of each bead is less than 33% of the height of the bumper beam cross-section, or the height of each bead is less than 25% of the height of the bumper beam cross-section. Most preferably, the height of each bead is less than 10 to 20% of the height of the bumper beam cross-section.

Also as used herein, the “impact face” of the bumper beam is a vertical surface of the bumper protruding away from the automobile body. However, since the bumper assembly can be used at a front end and a rear end of a vehicle, the impact face will vary. For example, the impact face of the bumper at the front end of the automobile is a front face of the bumper. While, alternatively, the impact face of the bumper at the rear end of the automobile is a back face of the bumper.

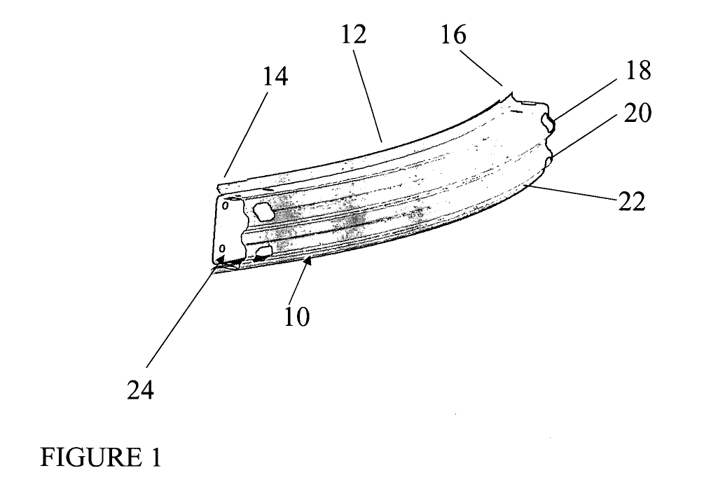

Specifically, FIG. 1 shows the bumper assembly according to the invention located within a vehicle fascia. The bumper assembly is comprised of a vehicular bumper beam 10 with a center 12 and two ends 14 and 16. The vehicular bumper beam 10 includes a structural member with two or more beads 18, 20 on an impact face 22 of the bumper beam. The bumper beam 10 may span the entire width of the automobile. The beads 18, 20 on bumper beam 10 assist in absorbing energy from a vehicular impact event, and may, in many cases, allow for the elimination of the energy absorber between the bumper beam and vehicle fascia. Thus, this modification from the prior art will result in increased impact resistance and may result in lower costs and weights of the bumper assembly when no energy absorber is used.

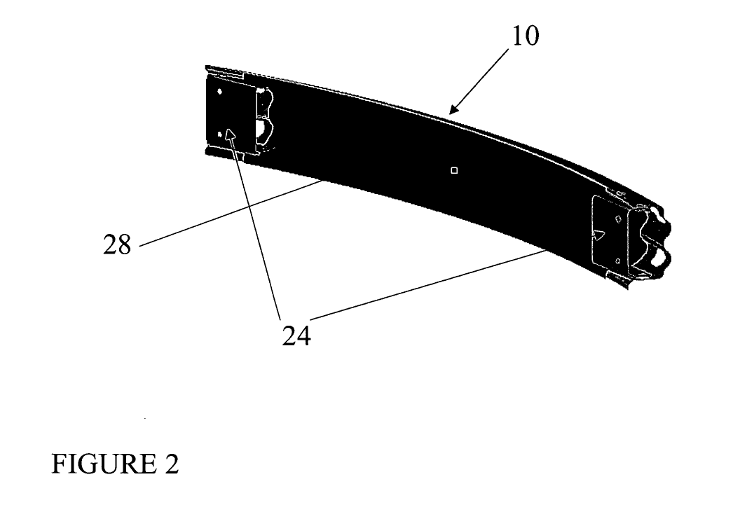

The bumper assembly may be mounted to the vehicle chassis or frame by a variety of means, including, as shown in FIG. 2, a pair of mounting brackets 24. The mounting brackets 24 attach the bumper beam at the two ends 14 and 16 to a vehicular frame or chassis. The pair of mounting brackets 24 are typically located at the end of a pair of frame rails (not shown), with the frame rails extending outward from the vehicular frame. The vehicular bumper beam 10 is attached to the pair of mounting brackets 24 by any suitable means including welding or bolting. The preferred means of attaching the mounting brackets 24 to the bumper beam 10 may depend on the bumper beam material and other cost considerations. For example, if the bumper beam is aluminum, the preferred method of attaching the mounting brackets may be by bolting them to the bumper beam. However, if the bumper beam is made from stainless steel, the preferred method of attaching the mounting brackets may be by welding.

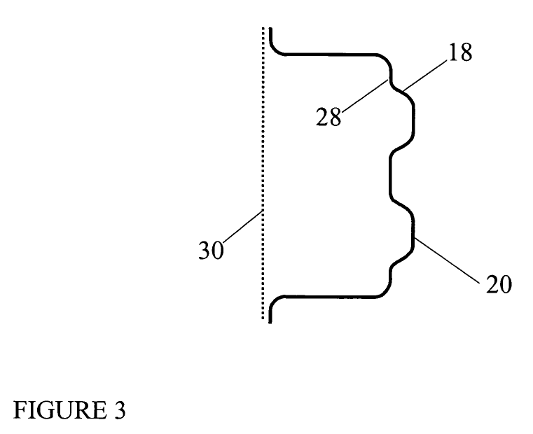

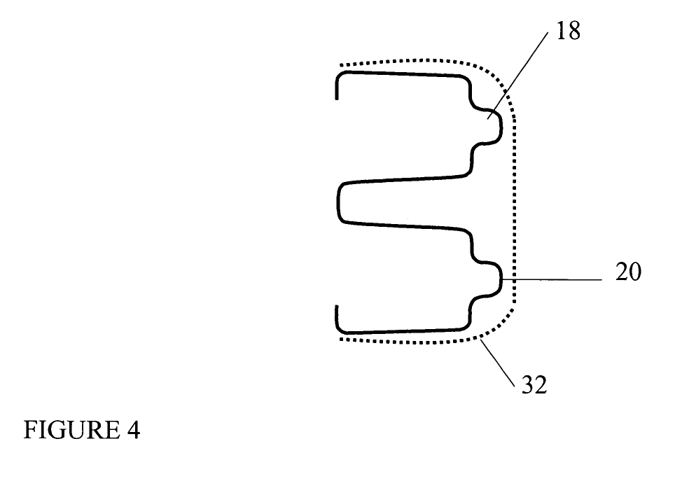

FIGS. 3 and 4 show cross-sectional views of two different embodiments of the bumper beam 10 of the present invention, designated by the overall shape of the cross-section. FIG. 3 shows a cross-sectional view of a “C-Type” bumper beam and FIG. 4 shows a cross-sectional view of an “M-Type” bumper beam 10 with stiffening beads 18, 20. In FIG. 3, the beads 18, 20 are a generally trapezoidal shape, with rounded corners. In FIG. 4, the beads are a generally square shape with rounded corners. The beads are formed by forming ridges in the bumper beam material longitudinally along the impact face of the bumper beam. In the present invention, two or more beads are added to the structural cross member of the bumper beam.

As shown in FIG. 3, the inner face 28 of the bumper beam is the inside face of the material that forms the bumper beam directly opposite of the impact face 22 of the bumper beam 10. Neither the C-Type section shown in FIG. 3 nor the M-Type section shown in FIG. 4 have a rear wall and thus they are considered to be “open section” designs. The bumper beam may also, optionally, have a rear wall that is formed generally along the plane defined by the non-impact side of the bumper beam, shown by dotted line 30 in FIG. 3, or a “closed section” design.

A bumper assembly typically comprises a bumper beam 10, mounting brackets 24 or other means of attaching the bumper beam 10 to the vehicle, and a fascia that covers the bumper beam and mounting brackets. The fascia may generally follow the contours of the impact face 22 of the bumper beam, as shown by the dotted line 32 in FIG. 4.

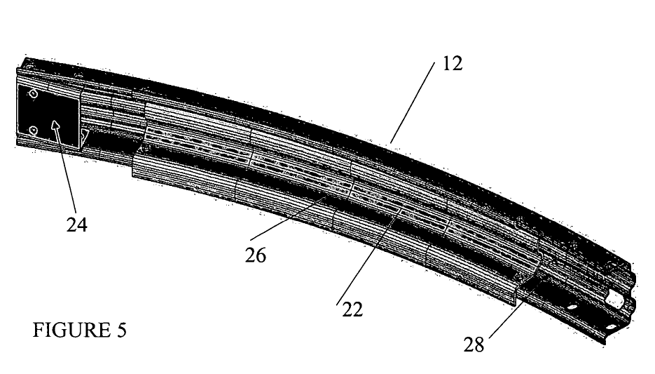

The most severe stresses are typically encountered during vehicular impact events that strike the center of the bumper. Thus, FIG. 5 shows a bumper assembly, which may further comprise a center reinforcement 26 at the center section 12 of the inner face 28 of the bumper beam 10. The cross-sectional contour of the center reinforcement generally follows the cross-sectional contour of the inner face 22, and may be securely attached to the bumper beam 10 by any suitable means including welding or bolting. Its length can vary from the 20% of the length of the bumper beam to the entire length of the bumper beam. More preferably, the length of the center reinforcement 26 can vary from 25% to 60% of length of the bumper beam. A mounting bracket 24 for the bumper assembly is also illustrated in FIG. 5.

The invention further relates to a process of fabricating a bumper beam of the present invention by any appropriate means, including by roll-forming or by extrusion, the bumper beam comprising a structural cross member with two or more beads on an impact face of the bumper beam Roll-form manufacturing may be preferable in some situations. Moreover, the process fabricates the bumper beam in open and closed cross sections, i.e., bumper beams with and without a rear wall.

The invention and is now described in such full, clear, concise and exact terms as to enable any person skilled in the art to which it pertains, to make the same. It is to be understood that the foregoing describes preferred embodiments of the present invention and that modifications may be made therein without departing from the spirit or scope of the invention as set forth in the claims.

We claim:

1. A vehicular bumper beam having two or more beads extending longitudinally on an impact face of the bumper beam.

2. The vehicular bumper beam of claim 1, wherein the bumper beam spans the width of a vehicle frame.

3. The vehicular bumper beam of claim 1, wherein each bead is comprised of a projecting shape formed integral with the bumper beam.

4. The vehicular bumper beam of claim 3, wherein the projecting shape of each bead is a semi-circular or semi-elliptical shape.

5. The vehicular bumper beam of claim 3, wherein the rounded type shape is semi-square or semi-rectangular shape.

6. The vehicular bumper beam of claim 3, wherein the projecting shape is a generally semi-triangular or semi-trapezoidal shape.

7. The vehicular bumper beam of claim 3, wherein each bead spans the entire length of the bumper beam.

8. The vehicular bumper beam of claim 4, wherein each bead has a height that is less than 50% of the height of the structural member.

9. The vehicular bumper beam of claim 1, wherein the bumper beam is an open section design.

10. The vehicular bumper beam of claim 1, wherein the bumper beam is a closed section design.

11. A bumper assembly comprising:
(a) a vehicular bumper beam, the vehicular bumper beam comprising a structural cross member with two or more beads on an impact face of the bumper beam;
(b) a pair of mounting brackets, the mounting brackets attaching the bumper beam to a vehicular frame; and
(c) a fascia, which at least partially encloses the vehicular bumper beam.

12. The bumper assembly of claim 11, wherein the bumper assembly further comprises an energy absorber located between the impact face of the vehicular bumper beam and the fascia.

13. The bumper assembly of claim 11, wherein the bumper assembly does not have an energy absorber located between the impact face of the vehicular bumper beam and the fascia.

14. The bumper assembly of claim 11, wherein the pair of mounting brackets are attached to the vehicular bumper beam by welding or bolting.

15. The bumper assembly of claim 11, further comprising a center reinforcement located at the center of the inner face of the bumper beam.

16. The bumper assembly of claim 15, wherein the center reinforcement is attached to the bumper beam by welding or bolting.

17. A method for making a bumper assembly, said method comprising the steps of
(a) roll-form manufacturing a bumper beam having two or more beads on an impact face of the bumper beam
(b) mounting the bumper beam on a vehicle; and
(c) enclosing at least a portion of the bumper beam in a fascia.

18. The process of fabricating a bumper assembly of claim 17, wherein the bumper beam is formed in an open section design.

19. The process of fabricating a bumper assembly of claim 17, wherein the bumper beam is formed in a closed section design.
